(19) United States
(12) Patent Application Publication
(10) Pub. No.: US 2018/0111401 A1
(43) Pub. Date: Apr. 26, 2018

(54) PATTERN WITH ENHANCED DYNAMIC OPTICALLY VARIABLE ANTI-COUNTERFEITING EFFECT AND PREPARATION METHOD THEREOF

(71) Applicants: CHINA BANKNOTE INK CO., LTD., SHANGHAI (CN); CHINA BANKNOTE PRINTING AND MINTING CORPORATION, BEIJING (CN)

(72) Inventors: XING ZHANG, SHANGHAI (CN); QINGFEI MENG, SHANGHAI (CN); YONG ZHANG, SHANGHAI (CN); XIAOQUAN ZHOU, SHANGHAI (CN); GUOLIN YUAN, SHANGHAI (CN); SHIFAN ZHANG, SHANGHAI (CN)

(73) Assignees: CHINA BANKNOTE INK CO., LTD., SHANGHAI (CN); CHINA BANKNOTE PRINTING AND MINTING CORPORATION, BEIJING (CN)

(21) Appl. No.: 15/565,829

(22) PCT Filed: Apr. 21, 2015
(86) PCT No.: PCT/CN2015/077038

§ 371 Date: Oct. 11, 2017

(30) Foreign Application Priority Data
Apr. 17, 2015 (CN) 201510185889.X

(51) Int. Cl. B41M 3/14; B42D 25/405; G02B 26/00

(52) U.S. Cl. CPC B41M 3/14; B42D 25/29; G02B 26/007; B42D 25/405

(57) ABSTRACT

An enhanced dynamic optically variable anti-counterfeiting effect and a preparation method thereof, comprises a full-page colored print form and a colored print form having high narrow stereoscopic lines, the colored print form having high narrow stereoscopic lines is overprinted on the full-page colored print form; the colored print form having high narrow stereoscopic lines has a shape of combined lines, comprising a curve line, a straight line, a dot matrix or a combination thereof; the interval of the lines is 100-300% times of the width of the lines, and the height of the lines is 10-100% times of the width of the lines; the color of the colored print form having high narrow stereoscopic lines is a complementary color of the color of the full-page colored print form in a color gamut space, or is visually significant different with the color of the full-page colored print form.

### BACKGROUND OF THE PRESENT INVENTION

### Field of Invention

The present invention relates to an anti-counterfeiting pattern and a preparation method thereof, and particularly relates to an enhanced dynamic optically variable anti-counterfeiting pattern and a preparation method thereof, which belongs to the anti-counterfeiting printing field.

### Description of Related Arts

The engraving gravure invisible pattern technology has been widely used in the banknote printing industry, and has become a popular readily identifiable anti-counterfeiting technology. Generally, the line number of the pattern of invisible part is identical to that of the pattern of visible part, with a texture comparison arrangement of 45-90 degree. However, in recent years, more generally, the engraving gravure is overprinted with an offset printing accurate design, wherein the engraving gravure is inkless blind embossing. Therefore, when rotationally observing, a gray level or optically variable effect is generated due to the angle changes between a highlight line of the pattern and the shadow thereof, but no dynamic effect.

A Chinese invention patent, with an application No. 200610020757.2, provides an invisible anti-counterfeiting pattern capable of generating dynamically variable engraving gravure, however, the pattern consists of parallel lines instead of curve structure, thereby it is unable to generate a dynamic color shifting effect.

A Chinese patent CN201310534864 provides an invisible anti-counterfeiting pattern capable of generating variable color for an engraving gravure. However, the pattern should be accurately overprinted with other graphic pattern (e.g., offset print), which has high requirement on the overprinting device, poor uniformity of the generating optical variation, and is unfavorable for wide application, particularly is limited in the application of banknotes, and has insufficient public identifiability.

A Chinese patent CN1262430 provides a data carrier having an optically variable structure, wherein the structure is combined by an engraving gravure relief structure and an overprinted print form, such that a part of the print form is visible when vertically viewing, and is invisible when obliquely viewing. Thereby, when alternately viewing vertically and obliquely, an oblique effect is generated, but no dynamic optically color changing effect when rotates.

In the known optically variable anti-counterfeiting print design, basically the offset line printing is disposed on the blind embossed side part, with the result of obvious comparison or oblique effect, but narrow optical color changing visual angle. Thus it requires for finding out an accurate observation angle, which is not suitable for quick observation. Besides, the optically variable effect is discontinuous and has no dynamic change.

### SUMMARY OF THE PRESENT INVENTION

In view of the above problems, the present invention provides a pattern with an enhanced dynamic optically variable anti-counterfeiting effect and a preparation method thereof, to solve the disadvantages in the prior art.

The anti-counterfeiting pattern with an enhanced dynamic optically variable anti-counterfeiting effect consists of a full-page colored print form and a colored print form having high narrow stereoscopic lines, wherein the colored print form having high narrow stereoscopic lines is overprinted on the full-page colored print form.

The full-page colored print form is lithography print form, a silk-screen print form or an engraving gravure print form or print form achieved by other ways.

The colored print form having high narrow stereoscopic lines is an engraving gravure print form.

The colored print form having high narrow stereoscopic lines has a shape of combined lines, comprising a curve line, a straight line, a dot matrix or a combination thereof; preferably, the lines are curve lines, or a combination structure which are predominately curve lines and assisted by straight lines and dots, or a combined curve structure, or curve lines of concentric circle structure, or curve lines with changed curvatures.

The interval of the lines is 100-300% times of the width of the lines, and the height of the lines is 10-100% times of the width of the lines.

Preferably, the width of the lines is 0.03-0.3 mm.

The color of the colored print form having high narrow stereoscopic lines is a complementary color of the color of the full-page colored print form in a color gamut space, or is visually significant different with the color of the full-page colored print form. The complementary color in the color gamut space is detailedly defined in the ink technology handbook, and any color pair of visually significant difference includes but is not limited to: yellow and red, yellow and violet, red and blue, yellow and green, red and white. The overprinting combination of two colored print forms causes a continuous and dynamic optically variable effect when the whole overprinting area is rotated along with the view angle. The anti-counterfeiting pattern having the above structure may realize a continuous optically variable effect when inclining or rotating a printed product, i.e., generate a distinct color changing effect when inclining 50-90 degree, and generate a color shifting effect when horizontal-rotating, which is extremely readily to identify.

The preparation method of the pattern with an enhanced dynamic optically variable anti-counterfeiting effect comprises the following steps of:

(1) performing a lithography print form, a silk-screen print form or an engraving gravure print form or print forms achieved by other ways on a printing carrier, such as a paper or plastic film, for example, the print may be an offset print, pad print, engraving gravure print or silk-screen print, and the graphic pattern is a full-page colored print;

(2) overprinting colored ink lines on the full-paged graphic pattern of lithography print or silk-screen print or engraving gravure print by using engraving gravure printing, wherein the colored ink has a complementary color of the printed color in step (1) in a color gamut space or of visually significant difference of the printed color in step (1), so as to obtain the pattern with the enhanced dynamic optically variable anti-counterfeiting effect.

In the design of the combined lines of the engraving gravure print, a fine pattern of a secret mark or specific graphic pattern for improving the wiping property may be added as needed.

As compared to the prior art, the present invention has the prominent technical effects that: an unique print color structure is formed by color overprinting of the two printing types and by contrasting color overprinting effect of the engraving gravure high narrow stereoscopic lines and the full-page colored print form. Thereby, it is realizable to generate a continuous optically variable effect when inclining or rotating a printed product, i.e., generate a distinct color changing effect when inclining, and a strong color shifting effect when horizontal-rotating, which is visual, readily to identify, anti-copying and difficult to forgery. The present invention enables to avoid a technology barrier of similar accurate overprinting technology, and is suitable for industrial application. The dynamic optically variable anti-counterfeiting pattern and the preparation method thereof can be applied in the anti-counterfeiting of securities.

### BRIEF DESCRIPTION OF THE DRAWINGS

FIG. 1 is a front view of a dynamic optically variable anti-counterfeiting concentric circle pattern.

FIG. 2 is a visual view of FIG. 1 with an inclined angle of 60 degree.

FIG. 3 is a visual view of FIG. 2 with a horizontal-rotation of 90 degree.

### DETAILED DESCRIPTION OF THE PREFERRED EMBODIMENTS

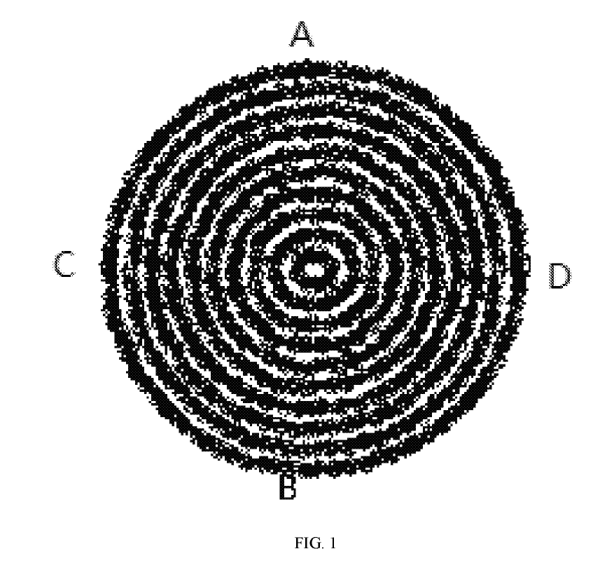

Please refer to FIG. 1, an anti-counterfeiting pattern with an enhanced dynamic optically variable anti-counterfeiting effect consists of a full-page colored print form 1 and a colored print form having high narrow stereoscopic lines 2, wherein the colored print form having high narrow stereoscopic lines 2 is overprinted on the full-page colored print form 1. As for the colored print form 2, the interval of the lines is 100-300% times of the width of the lines, and the height of the lines is 10-100% times of the width of the lines.

### Embodiment 1

Hereinafter, the present invention will be described by taken concentric circles as a graphic pattern as an example.

FIG. 1 is shown to a dynamic optically variable anti-counterfeiting concentric circle pattern, the preparation method of which is as below:

(1) adopting the offset printing to obtain a full-page colored print form 1, herein the graphic pattern is full-page yellow circles;

(2) adopting the engraving gravure to print the colored ink print, wherein the pattern is concentric circles, which overprints on the lithographic yellow circles, to obtain the colored print form 2 having high narrow stereoscopic lines; herein the ink of the engraving gravure is red;

(3) the high narrow stereoscopic lines of the red gravure print concentric circles has a width of 0.1 mm, a height of 0.06 mm, and an interval therebetween of 0.1 mm; the ABCD areas in FIG. 1 have uniform front color and vision.

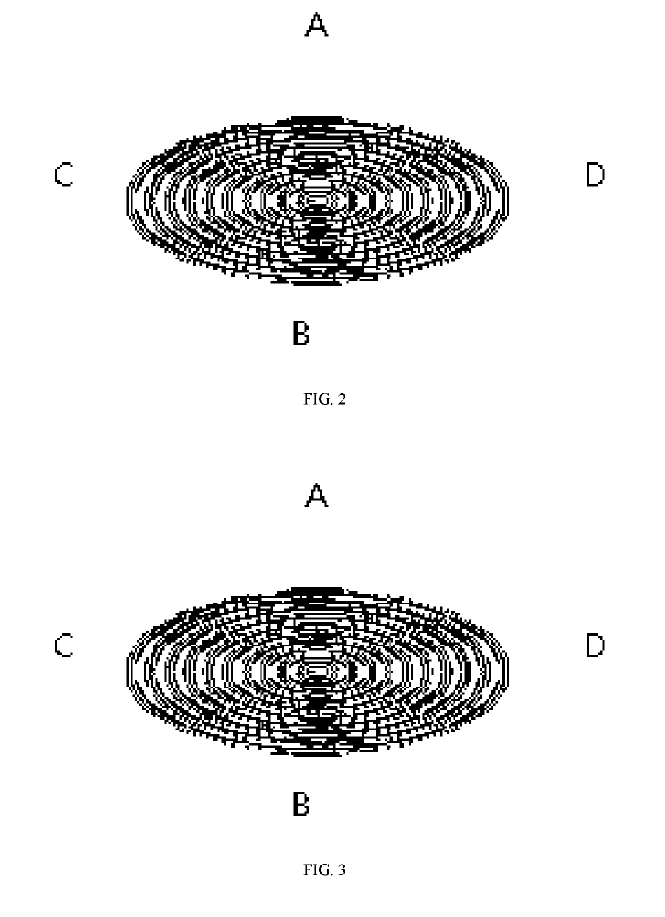

In the embodiment, the enhanced dynamic optically variable effect is as below: FIG. 2 is a visual view of FIG. 1 with an inclined angle of 60 degree, wherein areas A and B change to red of engraving gravure high narrow stereoscopic lines, while areas C and D are golden yellow by mixing the colors of the offset print shading and the engraving gravure, that is, areas A, B and areas C, D have contrasting colors. When FIG. 2 horizontal-rotates, a continuous dynamic optically variable effect is generated.

FIG. 3 is a visual view of FIG. 2 with a horizontal-rotation of 90 degree, wherein areas A and B are shifted from red in FIG. 2 to golden yellow, while areas C and D are shifted from golden yellow to red.

1. A pattern with an enhanced dynamic optically variable anti-counterfeiting effect, characterized in that, consisting of a full-page colored print form and a colored print form having high narrow stereoscopic lines, wherein the colored print form having high narrow stereoscopic lines is overprinted on the full-page colored print form;
the colored print form having high narrow stereoscopic lines has a shape of combined lines, comprising a curve line, a straight line, a dot matrix or a combination thereof;
the interval of the lines is 100-300% times of the width of the lines, and the height of the lines is 10-100% times of the width of the lines;
the color of the colored print form having high narrow stereoscopic lines is a complementary color of the color of the full-page colored print form in a color gamut space, or is visually significant different with the color of the full-page colored print form.

2. The pattern with an enhanced dynamic optically variable anti-counterfeiting effect according to claim 1, characterized in that, the full-page colored print form is lithography print form, a silk-screen print form or an engraving gravure print form or print form achieved by other ways; the colored print form having high narrow stereoscopic lines is an engraving gravure print form.

3. The pattern with an enhanced dynamic optically variable anti-counterfeiting effect according to claim 1, characterized in that, the colored print form having high narrow stereoscopic lines has a shape of curve lines, or a combination structure which are predominately curve lines and assisted by straight lines and dots, or a combined curve structure, or curve lines of concentric circle structure, or curve lines with changed curvatures.

4. The pattern with an enhanced dynamic optically variable anti-counterfeiting effect according to claim 1, characterized in that, the width of the lines is 0.03-0.3 mm.

5. The pattern with an enhanced dynamic optically variable anti-counterfeiting effect according to claim 1, characterized in that, any color pair of visually significant difference includes but is not limited to: yellow and red, yellow and violet, red and blue, yellow and green, red and white.

6. A preparation method of the pattern with an enhanced dynamic optically variable anti-counterfeiting effect according to claim 1, comprising the following steps of:
(1) performing a lithography print form, a silk-screen print form or an engraving gravure print form or print forms achieved by other ways on a printing carrier, such as a paper or plastic film, for example, the print may be an offset print, pad print, engraving gravure print or silk-screen print, and the graphic pattern is a full-page colored print;
(2) overprinting colored ink lines on the full-paged graphic pattern of lithography print or silk-screen print or engraving gravure print by using engraving gravure printing, wherein the colored ink has a complementary color of the printed color in step (1) in a color gamut space or of visually significant difference of the printed color in step (1), so as to obtain the pattern with the enhanced dynamic optically variable anti-counterfeiting effect.
